(19) United States
(12) Patent Application Publication
(10) Pub. No.: US 2009/0165830 A1
(43) Pub. Date: Jul. 2, 2009

(54) Ultrasound Actuator for Cleaning Objects

(75) Inventors: Christian Degel, Blieskastel (DE); Anette Jakob, St. Wendel (DE); Franz Josef Becker, Dillingen (DE)

Correspondence Address: BREINER & BREINER, L.L.C., P.O. BOX 320160, ALEXANDRIA, VA, 22320-0160, US

(73) Assignee: Fraunhofer-Gesellschaft zur Förderung der angweandten Forschung e.V., Munchen (DE)

(21) Appl. No.: 12/224,041

(22) PCT Filed: Feb. 9, 2007
(86) PCT No.: PCT/DE2007/000243

§ 371 Date: Sep. 30, 2008

(30) Foreign Application Priority Data
Feb. 17, 2006 (DE) 10 2006 007 459.9
Jul. 19, 2006 (DE) 10 2006 033 372.1

(51) Int. Cl. B08B 3/00

(52) U.S. Cl. 134/134

(57) ABSTRACT

The present invention relates to an ultrasound actuator for cleaning objects, having a propagation volume (3,4,13) for ultrasound, on which one or more ultrasonic transducers (5) are arranged. The propagation volume (3,4,13) is delimited by an acoustic coupling-out window (8) with a coupling face for acoustically coupling an object (1,12) to be cleaned and by one or more reflection faces (6,7) for coupled-in ultrasound. The ultrasonic transducers (5) are arranged on the propagation volume (3,4,13) such that the coupled-in ultrasound exits the propagation volume (3,4,13) via the coupling-out window (8) only after one or more reflections at the reflection faces (6,7). The reflection faces are designed such that a predeterminable distribution of the ultrasound energy without intensity peaks results at the coupling-out window (8). The present ultrasound actuator is used to achieve gentle cleaning of the objects with economic use of cleaning liquid.

### TECHNICAL FIELD OF APPLICATION

The present invention relates to an ultrasound actuator for cleaning objects, having a propagation volume for ultrasound and one or more ultrasound transducers for coupling-in ultrasound into the propagation volume.

The cleaning of components plays a important role in many technical areas. A particular problem is the cleaning of finely-structured components, for example, etched wafers from microsystems engineering. The increasing smaller structures have the result that particularly small particles are a great danger for the functionality of the components. The adhesive forces of a surface on a particle located close to the surface increase substantially with decreasing particle size so that these particles can only be removed from the surface with great difficulty.

### PRIOR ART

Ultrasound cleaning has been a commonly used method in industrial cleaning technology for a long time. Whereas ultrasound frequencies in the range of up to 100 kHz are used for cleaning surfaces with larger particles, ultrasound frequencies in the range around 1 MHz are required for small particles. Cleaning at these high ultrasound frequencies is also known by the term megasonic cleaning.

Many technical solutions for cleaning components use the so-called dipping technique in which the components to be cleaned are dipped into a liquid medium into which the ultrasound waves are coupled. However, this technique suffers on the one hand from a non-uniform cleaning effect and on the other hand requires a large quantity of cleaning fluid with the associated costs and problems relating to environmentally friendly disposal. An example of a cleaning system based on the dipping technique is described in EP 0546685 A2. In this case, the components to be cleaned are inserted into a tank filled with the cleaning liquid in which an ultrasound actuator configured as tubular is located underneath the components. In this case, the ultrasound actuator has a tubular housing on the inner wall whereof ultrasound transducers are arranged in the upper area. The irradiation of the ultrasonic waves in the frequency range around 1 MHz takes place through the tubular housing in the direction of the objects located in the tank.

In addition to this dipping technique, other solutions are also known in which the ultrasound actuators are located in the immediate vicinity of the components to be cleaned. These applications require only a small quantity of cleaning liquid. However, in this case locally very high intensities occur which, in addition to the desired cleaning effect, can also result in the destruction of the sensitive structures. An example for such a technique can be deduced from WO 00/21692 A1 which uses a large-area ultrasonic transducer parallel to and in the immediate vicinity of the wafer to be cleaned in this case.

Starting from this prior art, it is the object of the present invention to provide an ultrasound actuator for cleaning objects, in particular for cleaning components having small structures, which can be used to achieve gentle cleaning with economic use of cleaning liquid.

### DESCRIPTION OF THE INVENTION

The object is achieved with the ultrasound actuator according to claim 1. Advantageous embodiments of this ultrasound actuator are the subject matter of the dependent claims or can be deduced from the following description as well as the exemplary embodiments.

The present ultrasound actuator comprises a propagation volume for ultrasound as well as one or more ultrasonic transducers which are arranged on the propagation volume for coupling ultrasonic waves into the propagation volume during operation. The propagation volume is delimited by an acoustic coupling-out window with a coupling face for acoustically coupling an object to be cleaned and by one or more reflection faces for coupled-in ultrasound. In the present ultrasound actuator, the one or more ultrasonic transducers are arranged in such a manner on the propagation volume that the coupled-in ultrasound only exits the propagation volume via the coupling-out window only after one or more reflections at the reflection faces. The ultrasonic transducers therefore direct the ultrasound not directly onto the coupling-out window but onto one or more reflection faces. The one or more reflection faces are designed such that a predeterminable distribution of the ultrasound energy without intensity peaks results at the coupling-out window. This can comprise a uniform distribution or another predeterminable distribution, for example, having a maximum in the central region of the coupling-out window for more intensive cleaning of the object in this region.

A uniform distribution can possibly already be achieved by multiple reflection at plane reflection faces. For a specific three-dimensional or two-dimensional distribution of the sound energy at the coupling-out window, the reflection faces can also be curved, for example, concavely shaped. The reflection faces are preferably configured for a diffuse reflection of the ultrasound during operation of the ultrasound actuator.

As a result of this configuration of the ultrasound actuator having reflection faces, in particular for the diffuse reflection of the ultrasound, a distribution of the sound energy used at the coupling-out window without intensity peaks is achieved, for example, a uniform distribution. The object to be cleaned is placed in the area of the coupling face and if necessary, coupled with a medium. This medium can be a process or cleaning liquid. The present ultrasound actuator, which can be part of a cleaning device for objects, therefore requires no or only a small amount of cleaning or coupling liquid when used for cleaning an object.

A cleaning device with the present ultrasound actuator can be configured, for example, as described in WO 2004/114372 A1, whose disclosure content with regard to the cleaning device is included in the present patent application. In such a configuration, the present ultrasound actuator replaces the second plate with the ultrasound elements, as can be seen for example, in FIGS. 1 and 2 of WO 2004/114372 A1.

The propagation volume with its boundary faces can be configured in a different manner. In one embodiment of the present ultrasound actuator, the propagation volume is formed by a solid, for example, made of a metal or a ceramic. In this case, the reflection faces can thereby be obtained by means of a surface structuring of surface regions of the solid.

In another embodiment of the present ultrasound actuator, the propagation volume is occupied by a gas or a liquid. In this case, the reflection faces can be formed by suitably structured or formed walls of a solid material. Preferably, at least one of the reflection faces is flexibly configured in such a manner that it produces continuously changing reflection conditions during operation of the ultrasound actuator, which leads to a corresponding diffuse reflection of the ultrasound. This can be achieved, for example, by using a membrane which can be automatically set in motion by the coupled-in ultrasound. Naturally, however, other variable, for example, liquid boundary faces are also possible which provide for correspondingly varying reflection conditions and therefore for a varying energy distribution.

In principle, the reflection faces in the present ultrasound actuator can be arranged regularly and also randomly distributed around the propagation volume. In the present ultrasound actuator, the coupling-out window or its coupling face is preferably adapted to the shape of the surface of the object to be investigated. Furthermore, one or more channels can be configured in the ultrasound actuator which open into the coupling face so that a liquid coupling or cleaning medium can be introduced via the channels between the coupling face and the object surface.

The present ultrasound actuator can advantageously be used for cleaning components having small structures which must be cleaned from small particles in the size range of 1 μm or below. In this case, ultrasonic transducers are used which emit ultrasound in the wavelength range of ≧500 kHz. Naturally, however, the present ultrasound actuator can also be used for cleaning objects contaminated with larger particles. In this case, ultrasonic frequencies below 500 kHz are preferably used for the cleaning.

### BRIEF DESCRIPTION OF THE DRAWINGS

The present ultrasound actuator is explained briefly hereinafter with reference to exemplary embodiments in conjunction with the drawings without restricting the scope of protection predefined by the claims. In the figures:

FIG. 1 shows schematically a first example of an embodiment of the present ultrasound actuator;

FIG. 2 shows schematically a second example of an embodiment of the present ultrasound actuator;

FIG. 3 shows schematically another example of an embodiment of the present ultrasound actuator;

FIG. 4 shows an example of a cleaning device with the ultrasound actuator is a highly schematic diagram; and

FIG. 5 shows schematically an example of the external shape of the ultrasound actuator.

### WAYS FOR CARRYING OUT THE INVENTION

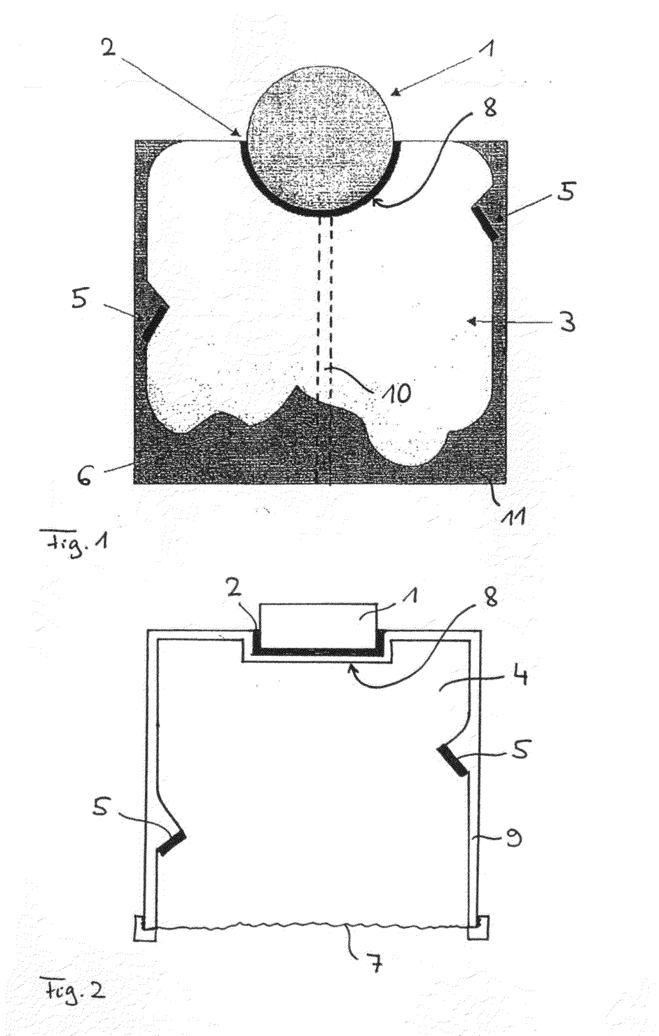

FIG. 1 shows schematically a first example of an embodiment of the present ultrasound actuator. In this example, the ultrasound actuator consists of a metal body 3 which forms the propagation volume for the ultrasound.

This metal body can consist, for example, of aluminium. In the front region on which the object 1 to be cleaned is placed, the metal body 3 has an acoustic coupling-out window 8, whose outer surface, designated in the present patent application as coupling face, is adapted to the shape of the object to be cleaned. In the example in FIG. 1, the object 1 to be cleaned is a ball so that the coupling face of the acoustic coupling-out window 8 is formed as hemispherical. A coupling liquid 2 is introduced between the ball and the coupling face of the coupling-out window 8. This coupling liquid for acoustic coupling can either be supplied externally or via a channel 10 optionally provided in the metal body 3, as indicated in FIG. 1.

Furthermore, a plurality of ultrasonic transducers 5 are attached to the metal body 3 in such a manner that they direct the ultrasound not onto the coupling-out window 8 but onto a reflection face 6 of the metal body 3 formed on the back side. This reflection face 6 is formed by structuring the rear surface of the metal body 3 in such a manner that the impinging ultrasound is diffusely reflected from this surface.

In this example, the ultrasonic transducers 5 are configured as piezoactuators for a high frequency range (megasound) which introduce the required sound energy into the metal body 3. The introduced energy is distributed in the metal body 3 as a result of the reflections at the reflection face 6 and other boundary faces and can only exit in the area of the coupling-out window 8 by producing an acoustically conducting contact, for example, by the cleaning or coupling liquid 2 and impinge upon the object 1 to be cleaned. As a result of the diffuse reflection, a uniform distribution of energy is achieved in the area of the coupling-out window and thus gentle and uniform cleaning of the surface of the object 1 is achieved. In this example, the metal body 3 is embedded in a foam material 11 having plane outer surfaces to facilitate its handling.

FIG. 2 shows another example of an ultrasound actuator according to the present invention in which a cubic object 1 is to be cleaned. Here also the coupling face of the acoustic coupling-out window 8 is adapted to the surface of the object 1. In this example, the propagation volume is filled with a gas 4 and is delimited in the front region by the coupling-out window 8 and in the rearward region by a flexible membrane 7. The remaining boundary walls 9 consist of a plastic material to which the ultrasonic transducers 5 are attached. In this example, the reflection face is formed by the membrane 7 which is set in motion as a result of the coupling-in of the ultrasound and thus effects diffuse reflection of the impinging waves as a result of the continuous movement. In such an embodiment the coupled-in ultrasound energy is thus distributed approximately uniformly due to the diffuse reflection so that no more intensity peaks occur at the coupling-out window 8.

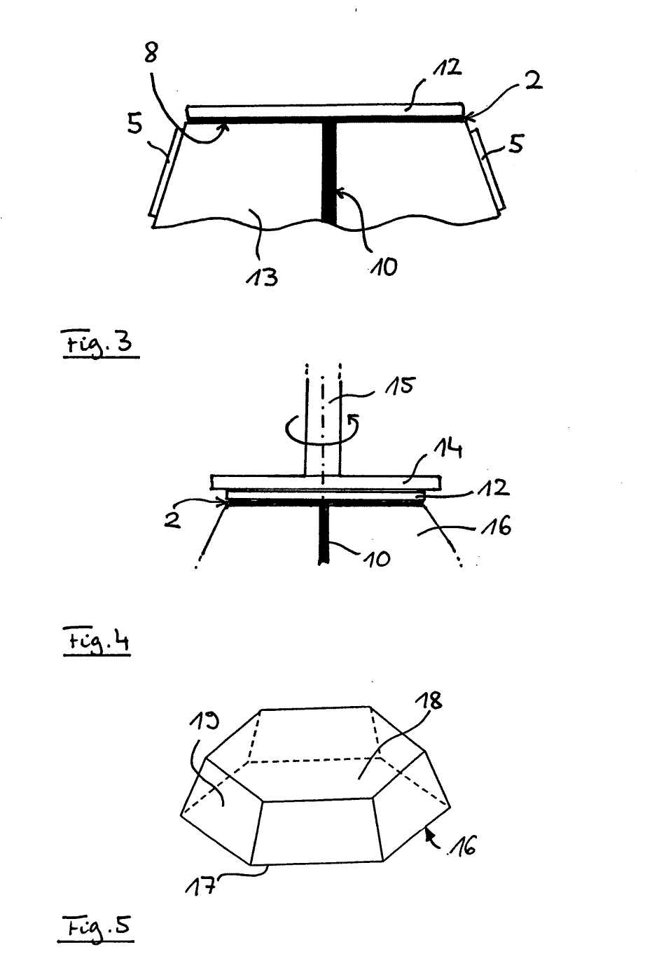

The ultrasound actuator can also advantageously be used for the cleaning of disk-shaped objects as indicated in FIG. 3. In this case, the coupling face of the acoustic coupling-out window 8 is designed as flat for adaptation to the disk-shaped object 12. In this example, a coupling liquid 2 is passed between the object 12 to be cleaned and the coupling face of the coupling-out window 8, which can also have an additional cleaning function, for example, as a cleaning fluid. The coupling liquid 2 is supplied via a channel 10 which is formed in the propagation volume 13 with the reflection faces. The ultrasonic transducers 5 arranged on the propagation volume 13 are indicated in the figure.

FIG. 4 shows an example of a cleaning device with the ultrasound actuator 16 in a highly schematic diagram. The device comprises a holder 14 for the disk-shaped objects 12 to be cleaned, for example, wafers and a rotational drive 15 for this holder 14. In this case, the holder 14 is configured with corresponding gripping elements not shown in the figure. The ultrasound actuator 16 located opposite to the holder 14 is configured in this example according to FIG. 3. This device makes it possible to rotate the object 12 to be cleaned during cleaning.

FIG. 5 finally shows schematically an example for the outer shape of the ultrasound actuator 16 or the body forming the propagation volume in perspective view such as can be used, for example in the device according to FIG. 4. This polyhedral body has a first 17 and a second face 18 which are parallel to one another as well as a plurality of side faces 19 which each include an acute angle to the first face 17. The ultrasonic oscillators are acoustically coupled to the side faces 19 of the polyhedral body which can, for example, comprise a truncated prism.

### REFERENCE LIST

### 1 Object

2 Coupling liquid
3 Metal body

### 4 Gas

5 Ultrasonic transducer
6 Reflection face

### 7 Membrane

8 Coupling-out window

### 9 Wall

### 10 Channel

### 11 Foam

12 Disk-shaped object
13 Propagation volume

### 14 Holder

15 Rotational drive
16 Ultrasound actuator
17 First face
18 Second face
19 Side faces

1-11. (canceled)

12. An ultrasound actuator for cleaning objects comprising
a propagation volume for ultrasound which is delimited by an acoustic coupling-out window with a coupling face for acoustically coupling an object to be cleaned and by at least one reflection face for coupled-in ultrasound, and
at least one ultrasonic transducer for coupling in ultrasound which is arranged such that on the propagation volume the at least one ultrasonic transducer directs the ultrasound away from the coupling-out window onto said at least one reflection face such that the coupled-in ultrasound exits the propagation volume via the coupling-out window only after at least one reflection at the at least one reflection face.

13. The ultrasound actuator according to claim 12, wherein the at least one reflection face is configured for a diffuse reflection of the ultrasound.

14. The ultrasound actuator according to claim 12, wherein the propagation volume is provided by a solid of which at least one surface region is structured to produce at least one reflection face with diffuse reflection.

15. The ultrasound actuator according to claim 12, wherein the propagation volume is provided by a solid.

16. The ultrasound actuator according to claim 12, wherein the propagation volume is occupied by a liquid or a gas.

17. The ultrasound actuator according to claim 16, wherein at least one of the at least one reflection face is flexibly configured in such a manner to produce continuously changing reflection conditions due to movement.

18. The ultrasound actuator according to claim 17, wherein the at least one of the at least one reflection face is a membrane.

19. The ultrasound actuator according to claim 12, further comprising at least one channel for supplying a liquid coupling medium opens into the coupling face of the coupling-out window.

20. The ultrasound actuator according to claim 12, wherein the at least one ultrasonic transducer is configured for generating ultrasound in a range ≧500 kHz.

21. The ultrasound actuator according to claim 12, wherein the coupling face is adapted to a shape of an object to be cleaned and configured to allow insertion of a thin film of a liquid cleaning and/or coupling medium between the object and the coupling face in use.

22. A device for cleaning a disk-shaped object containing an ultrasound actuator according to claim 12.

23. A device for cleaning a disk-shaped object containing an ultrasound actuator according to one of claims 12 to 20, comprising a holder for the disk-shaped object and a rotational drive connected to the holder or to the ultrasound actuator in order to generate a rotational relative movement between the disk-shaped object and the ultrasound actuator during cleaning of the object.
